(19) United States
(12) Patent Application Publication
(10) Pub. No.: US 2026/0371048 A1
(43) Pub. Date: Nov. 19, 2026

(54) ELECTRONIC AND ELECTRICAL SYSTEM AND VEHICLE

(71) Applicant: BYD COMPANY LIMITED, Shenzhen (CN)

(72) Inventors: Yilin ZHONG, Shenzhen (CN); Wei WANG, Shenzhen (CN); Heng MO, Shenzhen (CN); Yibo BAI, Shenzhen (CN); Xianhui HUANG, Shenzhen (CN)

(73) Assignee: BYD COMPANY LIMITED, Shenzhen (CN)

(21) Appl. No.: 19/732,729

(22) Filed: Jul. 7, 2026

Related U.S. Application Data
(63) Continuation of application No. PCT/CN2025/070445, filed on Jan. 3, 2025.

(30) Foreign Application Priority Data
Jan. 16, 2024 (CN) 202410067961.8

(51) Int. Cl. H04W 4/48

(52) U.S. Cl. CPC H04W 4/48

(57) ABSTRACT

An electronic and electrical system and a vehicle are disclosed. The electronic and electrical system includes a first component and a second component. The electronic and electrical system further includes a first communication link and a second communication link that communicatively connect the first component and the second component, and the first component and the second component are configured to communicate with each other through at least one of the first communication link or the second communication link.

### CROSS-REFERENCE TO RELATED APPLICATIONS

This application claims the benefit of International Application No. PCT/CN2025/070445, filed on Jan. 3, 2025, which claims priority to Chinese Patent Application No. 202410067961.8, filed on Jan. 16, 2024. The disclosures of the prior applications are incorporated herein by reference in their entirety.

### TECHNICAL FIELD

The present disclosure relates to the field of vehicle technology, and in particular, to an electronic and electrical system and a vehicle.

### BACKGROUND

In a related technology, as a vehicle continuously develops towards electrification, network interconnection, and intelligence, an increasing quantity of functions are carried on the vehicle, and an electronic and electrical architecture of an entire vehicle is increasingly complex. More and more increasingly advanced electronic and electrical components are introduced into the vehicle, and communication requirements between the electronic and electrical components are also increasing. Vehicle-wide implementation of each function of the vehicle may rely on an electronic and electrical system of the vehicle.

### SUMMARY

According to a first aspect, some embodiments of the present disclosure provide an electronic and electrical system. The electronic and electrical system includes a first component and a second component. The electronic and electrical system further includes a first communication link and a second communication link that communicatively connect the first component and the second component. The first component and the second component communicate with each other through at least one of the first communication link or the second communication link.

In some embodiments, communication types of the first communication link and the second communication link are the same, or communication types of the first communication link and the second communication link are different.

In some embodiments, the electronic and electrical system satisfies at least one of the following: a communication type of the first communication link is one of Ethernet communication, controller area network (CAN) communication, optical fiber communication, Wi-Fi communication, or Bluetooth communication; or a communication type of the second communication link is one of Ethernet communication, CAN communication, optical fiber communication, Wi-Fi communication, or Bluetooth communication.

In some embodiments, the communication types of the first communication link and the second communication link are the same, the electronic and electrical system further includes a third communication link communicatively connecting the first component and the second component, a communication type of the third communication link is different from the communication type of the first communication link, and the third communication link communicatively connects the first component and the second component.

In some embodiments, the electronic and electrical system further includes a fourth communication link communicatively connecting the first component and the second component, a communication type of the fourth communication link is the same as the communication type of the third communication link, and the fourth communication link communicatively connects the first component and the second component.

In some embodiments, a communication type of the third communication link is one of Ethernet communication, CAN communication, optical fiber communication, Wi-Fi communication, or Bluetooth communication.

In some embodiments, the first component and the second component are configured to communicate with each other through the second communication link when the first communication link is in a fault state.

In some embodiments, the first component and the second component are configured to communicate with each other through the first communication link and the second communication link when the first communication link cannot independently satisfy a service requirement.

In some embodiments, the electronic and electrical system satisfies at least one of the following: the first component is one of a controller, a sensor, or an executor; or the second component is one of a controller, a sensor, or an executor.

In some embodiments, at least one of the first component or the second component is a domain controller.

In some embodiments, the first component is configured to implement a first function, and the second component is configured to implement the first function when the first component is in a first state.

In some embodiments, the first state includes one of a fault state and a state in which the first component cannot independently satisfy a service requirement.

In some embodiments, the first function includes at least one of a power control function, a steering function, a braking function, a body control function, or a chassis control function.

In some embodiments, the first component is a first domain controller of the vehicle, and the second component is a cross-domain computing controller of the vehicle.

In some embodiments, the electronic and electrical system further includes a third component, and the third component is connected to the first communication link and is located between the first component and the second component.

In some embodiments, the electronic and electrical system further includes a fourth component, and the fourth component is connected to the second communication link and is located between the first component and the second component.

In some embodiments, the electronic and electrical system satisfies at least one of the following: the third component is one of a controller, a sensor, or an executor; or the fourth component is one of a controller, a sensor, or an executor.

In some embodiments, the third component is a front area controller of the vehicle, and the fourth component is a rear area controller of the vehicle.

According to a second aspect, some embodiments of the present disclosure provide a vehicle, including the foregoing electronic and electrical system.

### BRIEF DESCRIPTION OF THE DRAWINGS

FIG. 1 is a diagram of a network architecture of a communication system according to some embodiments of the present disclosure.

FIG. 2 is a diagram of a network architecture of a communication system according to some embodiments of the present disclosure.

FIG. 3 is a diagram of a network architecture of a communication system according to some embodiments of the present disclosure.

FIG. 4 is a diagram of a network architecture of a communication system according to some embodiments of the present disclosure.

FIG. 5 is a diagram of a network architecture of a communication system according to some embodiments of the present disclosure.

FIG. 6 is a diagram of a network architecture of a communication system according to some embodiments of the present disclosure.

FIG. 7 is a diagram of a network architecture of a communication system according to some embodiments of the present disclosure.

FIG. 8 is a diagram of a network architecture of a communication system according to some embodiments of the present disclosure.

FIG. 9 is a diagram of a network architecture of a communication system according to some embodiments of the present disclosure.

FIG. 10 is a diagram of a network architecture of a communication system according to some embodiments of the present disclosure.

FIG. 11 is a diagram of a network architecture of a communication system according to some embodiments of the present disclosure.

FIG. 12 is a diagram of a network architecture of a communication system according to some embodiments of the present disclosure.

FIG. 13 is a diagram of a network architecture of a communication system according to some embodiments of the present disclosure.

FIG. 14 is a diagram of a network architecture of a communication system according to some embodiments of the present disclosure.

FIG. 15 is a diagram of a network architecture of a communication system according to some embodiments of the present disclosure.

FIG. 16 is a diagram of a network architecture of a communication system according to some embodiments of the present disclosure.

FIG. 17 is a diagram of a network architecture of a communication system of a vehicle according to some embodiments of the present disclosure; and

FIG. 18 is a diagram of a vehicle according to some embodiments of the present disclosure.

Reference numerals: Electronic and electrical system 10, first component 11, second component 12, third component 13, fourth component 14, fifth component 15, sixth component 16, first communication link 21, second communication link 22, third communication link 23, fourth communication link 24, power controller 101, steering and braking controller 102, body controller 103, and chassis controller 104.

### DETAILED DESCRIPTION

The following describes the technical solutions in some embodiments of the present disclosure with reference to the accompanying drawings.

Because a large quantity of high-end electronic and electrical components may be introduced into a vehicle, a communication requirement between the electronic and electrical components may be large, and implementation of each function of the vehicle may depend on an electronic and electrical system of the vehicle. If a fault occurs in an electronic and electrical architecture of a complete vehicle, use of the vehicle may be affected.

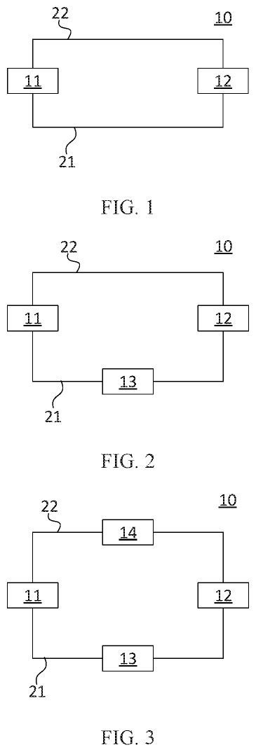

FIG. 1 is a diagram of an architecture of an electronic and electrical system 10 according to some embodiments of the present disclosure. As shown in FIG. 1, the electronic and electrical system 10 includes a first component 11, a second component 12, a first communication link 21, and a second communication link 22. The first communication link 21 communicatively connects the first component 11 and the second component 12, and the second communication link 22 communicatively connects the first component 11 and the second component 12. The first component 11 and the second component 12 may communicate with each other through the first communication link 21. Alternatively, the first component 11 and the second component 12 may communicate with each other through the second communication link 22. Alternatively, the first component 11 and the second component 12 may communicate with each other through the first communication link 21 and the second communication link 22.

In different running states of the electronic and electrical system 10, the first component 11 and the second component 12 may communicate with each other through different communication links.

For example, when the first communication link 21 between the first component 11 and the second component 12 is faulty, the first component 11 and the second component 12 may implement communication between the first component 11 and the second component 12 through the second communication link 22.

For another example, when the first communication link 21 cannot support a communication requirement, the first component 11 and the second component 12 may communicate with each other through the second communication link 22. Alternatively, the first component 11 and the second component 12 may communicate with each other through the first communication link 21 and the second communication link 22, to better satisfy a transmission requirement between the first component 11 and the second component 12. Therefore, reliability of the electronic and electrical system 10 of a vehicle can be improved.

For example, a case in which the first communication link 21 cannot support a transmission requirement may include, but is not limited to, a case in which a transmission resource of the first communication link 21 is insufficient to satisfy the transmission requirement between the first component 11 and the second component 12.

In some embodiments, a communication type of the first communication link 21 may be one of Ethernet communication, controller area network (CAN) communication, optical fiber communication, Wi-Fi communication, or Bluetooth communication.

In some embodiments, a communication type of the second communication link 22 may be one of Ethernet communication, CAN communication, optical fiber communication, Wi-Fi communication, or Bluetooth communication.

Some embodiments of the present disclosure are described below with reference to the accompanying drawings.

In some embodiments, as shown in FIG. 1, the communication types of the first communication link 21 and the second communication link 22 are the same.

For example, the first communication link 21 is Ethernet communication, and the second communication link 22 is Ethernet communication. Alternatively, the first communication link 21 is CAN communication, and the second communication link 22 is CAN communication. In this solution, the first communication link 21 and the second communication link 22 are redundant paths of a same communication type.

It may be understood that, in this solution, the first communication link 21 and the second communication link 22 may form a ring loop to form a path redundancy architecture of a ring network architecture. In addition, because the first communication link 21 and the second communication link 22 use the same communication type, communication link switching can be more conveniently performed, so that stability of the electronic and electrical system 10 is improved, and control is convenient.

In some embodiments, as shown in FIG. 1, the first component 11 and the second component 12 may be set to be mutually independent and serve as backups for each other. In a vehicle, the first component 11 may include a cross-domain computing controller, and the second component 12 may include a right area controller. The cross-domain computing controller and the right area controller use an inter-domain redundancy design. Both the cross-domain computing controller and the right area controller may include a power control function, a steering and braking function, a body control function, and a chassis control function. When a problem occurs on any one of two domain controllers (such as the cross-domain computing controller and the right area controller), the power control function, the steering and braking function, the body control function, and the chassis control function can still run normally.

In some examples, as shown in FIG. 2, the electronic and electrical system 10 further includes a third component 13. The third component 13 is connected to the first communication link 21 and is located between the first component 11 and the second component 12. In this way, communication between components may be implemented through the ring loop formed by the first communication link 21 and the second communication link 22.

For example, when a communication fault occurs on a link of the first communication link 21 between the first component 11 and the third component 13, the third component 13 can communicate with the second component 12 through a link of the first communication link 21 between the second component 12 and the third component 13. Alternatively, the third component 13 can communicate with the first component 11 by using the second component 12 through the second communication link 22.

For another example, when a communication fault occurs on a link of the first communication link 21 between the second component 12 and the third component 13, the third component 13 can communicate with the first component 11 through a link of the first communication link 21 between the first component 11 and the third component 13. Alternatively, the third component 13 can communicate with the second component 12 by using the first component 11 through the second communication link 22.

It may be understood that there is a redundant communication path between two components in the ring loop formed by the first communication link 21 and the second communication link 22. In this way, when one communication path between the two components is faulty, communication between the two components may be implemented through the other communication path.

In some other examples, as shown in FIG. 3, the electronic and electrical system further includes a fourth component 14. The fourth component 14 is connected to the second communication link 22 and is located between the first component 11 and the second component 12. In this way, communication between components may be implemented through the ring loop formed by the first communication link 21 and the second communication link 22.

For example, when a communication fault occurs on a link of the second communication link 22 between the first component 11 and the fourth component 14, the fourth component 14 can communicate with the second component 12 through a link of the second communication link 22 between the second component 12 and the fourth component 14. Alternatively, the fourth component 14 can communicate with the first component 11 by using the second component 12 through the first communication link 21.

For another example, when a communication fault occurs on a link of the second communication link 22 between the second component 12 and the fourth component 14, the fourth component 14 can communicate with the first component 11 through a link of the second communication link 22 between the first component 11 and the fourth component 14. Alternatively, the fourth component 14 can communicate with the second component 12 by using the first component 11 through the first communication link 21.

It may be understood that the first communication link 21 and the second communication link 22 form a ring communication network, another component may be connected to the first communication link 21 or the second communication link 22, and any two components connected to the first communication link 21 or the second communication link 22 have a redundant communication path. With this ring communication network mounted on the vehicle, reliability of communication between components of the electronic and electrical system of the vehicle can be improved.

In the vehicle, the first component 11 may include a cross-domain computing controller, and the second component 12 may include a right area controller. In addition, the vehicle 100 further includes a front area controller, a rear area controller, an intelligent driving domain controller, and a cockpit domain controller. The cross-domain computing controller, the right area controller, the front area controller, the rear area controller, the intelligent driving domain controller, and the cockpit domain controller may implement multi-end and multi-path interconnection between each other through an Ethernet, a CAN bus, and a local interconnect network (Local Interconnect Network, LIN) bus. After one connection path of an Ethernet, a CAN bus, and a LIN bus between any two domain controllers is disconnected, a connection can still be implemented through an Ethernet, a CAN bus, or a LIN bus that is not disconnected. Alternatively, a connection between domain controllers is implemented and disconnected through an indirect connection of another domain controller, to implement path redundancy and bus redundancy functions between the domain controllers.

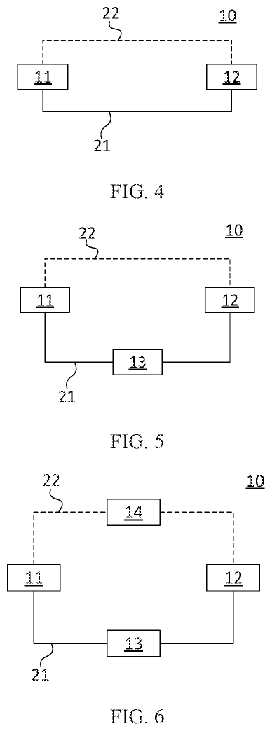

In some other embodiments, as shown in FIG. 4, communication types of the first communication link 21 and the second communication link 22 are different.

For example, the first communication link 21 is Ethernet communication, and the second communication link 22 is CAN communication; or the first communication link 21 is Wi-Fi communication, and the second communication link 22 is optical fiber communication, or the like. In this solution, the first communication link 21 and the second communication link 22 are redundant paths of different communication types, and may be constructed as bus redundancy. When the first communication link 21 is faulty or the first communication link 21 cannot support a transmission requirement, communication between the first component 11 and the second component 12 may be implemented through the second communication link 22.

It may be understood that in this solution, the first communication link 21 and the second communication link 22 may form different types of communication redundancy, and when the first communication link 21 is faulty or cannot support a transmission requirement, communication between the first component 11 and the second component 12 may be implemented through the second communication link 22.

In addition, in some examples, as shown in FIG. 5, the electronic and electrical system 10 may further include a third component 13. The third component 13 is connected to the first communication link 21 and is located between the first component 11 and the second component 12. In this way, communication between components may be implemented through the ring loop formed by the first communication link 21 and the second communication link 22.

In some other examples, as shown in FIG. 6, the electronic and electrical system may further include a fourth component 14. The fourth component 14 is connected to the second communication link 22 and is located between the first component 11 and the second component 12. In this way, communication between components may be implemented through the ring loop formed by the first communication link 21 and the second communication link 22.

In some embodiments, as shown in FIG. 7, the electronic and electrical system 10 further includes a third communication link 23. The third communication link 23 communicatively connects the first component 11 and the second component 12, and the third communication link 23 is used for communication between the first component 11 and the second component 12.

For example, the first component 11 and the second component 12 communicate with each other through at least one of the first communication link 21, the second communication link 22, and the third communication link 23.

It should be noted that “at least one of A, B, and C” has the same meaning as “at least one of A, B, or C” and both include the following combinations of A, B, and C: only A, only B, only C, a combination of A and B, a combination of A and C, a combination of B and C, and a combination of A, B, and C.

For example, when the first communication link 21 between the first component 11 and the second component 12 is faulty, the first component 11 and the second component 12 may implement communication between the first component 11 and the second component 12 through at least one of the second communication link 22 or the third communication link 23.

For another example, when the first communication link 21 cannot support a communication requirement, the first component 11 and the second component 12 may communicate with each other through the second communication link 22. Alternatively, the first component 11 and the second component 12 may communicate with each other through the third communication link 23. Alternatively, the first component 11 and the second component 12 may communicate with each other through at least two of the first communication link 21, the second communication link 22, and the third communication link 23, to better satisfy a transmission requirement between the first component 11 and the second component 12. Therefore, reliability of the electronic and electrical system 10 of a vehicle can be improved.

In some embodiments of the present disclosure, a redundant communication link is provided between the first component 11 and the second component 12. In this solution, communication abnormality between the first component 11 and the second component 12 caused due to that a communication link between the first component 11 and the second component 12 is faulty or a communication link cannot satisfy a communication requirement can be avoided.

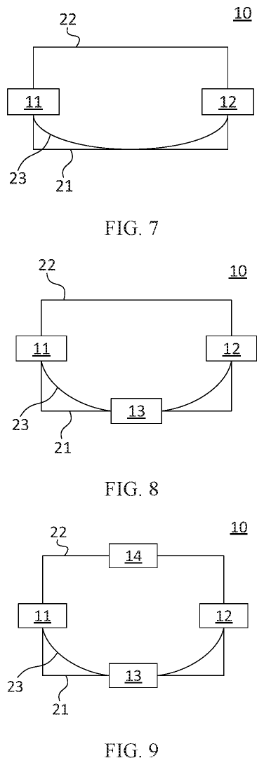

In some examples, as shown in FIG. 8, the electronic and electrical system 10 further includes a third component 13, and the third component 13 is connected to the first communication link 21 and the third communication link 23 and is located between the first component 11 and the second component 12. In this way, communication between components can be implemented through a redundancy design of the first communication link 21, the second communication link 22, and the third communication link 23.

For example, when a communication fault occurs on a link of the first communication link 21 between the first component 11 and the third component 13, the third component 13 can communicate with the second component 12 through a link of the first communication link 21 between the second component 12 and the third component 13. Alternatively, the third component 13 can communicate with the first component 11 by using the second component 12 through the second communication link 22. Alternatively, the third component 13 can communicate with the second component 12 through a link of the third communication link 23 between the second component 12 and the third component 13. Alternatively, the third component 13 can communicate with the first component 11 through a link of the third communication link 23 between the first component 11 and the third component 13.

In some other examples, as shown in FIG. 9, the electronic and electrical system 10 further includes a fourth component 14. The fourth component 14 is connected to the second communication link 22 and is located between the first component 11 and the second component 12. In this way, communication between components can be implemented through a redundancy design of the first communication link 21, the second communication link 22, and the third communication link 23.

For example, when a communication fault occurs on a link of the second communication link 22 between the first component 11 and the fourth component 14, the fourth component 14 can communicate with the second component 12 through a link of the second communication link 22 between the second component 12 and the fourth component 14. Alternatively, the fourth component 14 can communicate with the first component 11 by using the second component 12 through at least one of the first communication link 21 or the third communication link 23.

In some embodiments, a communication type of the third communication link 23 is one of Ethernet communication, CAN communication, optical fiber communication, Wi-Fi communication, and Bluetooth communication. The communication types of the first communication link 21, the second communication link 22, and the third communication link 23 may be set to be different from each other, or at least two are the same.

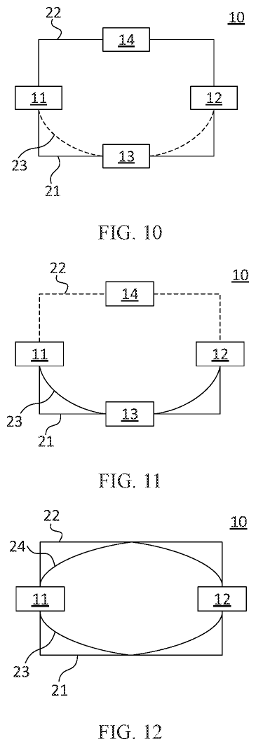

In some examples, as shown in FIG. 10, the communication types of the first communication link 21 and the second communication link 22 are the same, and the communication type of the third communication link 23 is different from the communication type of the first communication link 21, thereby constructing a path redundancy architecture and a bus redundancy architecture. For example, the first communication link 21 is the Ethernet communication, the second communication link 22 is the Ethernet communication, and the third communication link 23 is CAN communication. Alternatively, the first communication link 21 is the Wi-Fi communication, the second communication link 22 is the Wi-Fi communication, and the third communication link 23 is optical fiber communication.

It may be understood that, in this solution, the first communication link 21 and the second communication link 22 may form a ring loop. However, the third communication link 23 forms a communication link of a different communication type outside a ring network. In addition, the first communication link 21 and the second communication link 22 are redundant paths of a same communication type. When the first communication link 21 is faulty or the first communication link 21 cannot support a transmission requirement, communication between the first component 11 and the second component 12 may be implemented through the second communication link 22. When a ring network communication link formed by the first communication link 21 and the second communication link 22 is faulty or cannot support a transmission requirement, communication between the first component 11 and the second component 12 may be implemented through the third communication link 23.

In some other examples, as shown in FIG. 11, the communication types of the first communication link 21 and the second communication link 22 are different, and the communication type of the third communication link 23 is the same as the communication type of the first communication link 21. For example, the first communication link 21 is Ethernet communication, the second communication link 22 is CAN communication, and the third communication link 23 is the Ethernet communication. Alternatively, the first communication link 21 is Wi-Fi communication, the second communication link 22 is optical fiber communication, and the third communication link 23 is the Wi-Fi communication.

It may be understood that, in this solution, the first communication link 21 and the third communication link 23 may form a ring loop. However, the second communication link 22 forms a communication link of a different communication type outside a ring network, thereby constructing a path redundancy architecture and a bus redundancy architecture.

In some embodiments, as shown in FIG. 12, the electronic and electrical system 10 further includes a third communication link 23 and a fourth communication link 24. The third communication link 23 communicatively connects the first component 11 and the second component 12, and the third communication link 23 is used for communication between the first component 11 and the second component 12. The fourth communication link 24 communicatively connects the first component 11 and the second component 12, and the fourth communication link 24 is used for communication between the first component 11 and the second component 12.

The first component 11 and the second component 12 communicate with each other through at least one of the first communication link 21, the second communication link 22, the third communication link 23, and the fourth communication link 24.

For example, when the first communication link 21 between the first component 11 and the second component 12 is faulty, the first component 11 and the second component 12 may implement communication between the first component 11 and the second component 12 through at least one of the second communication link 22, the third communication link 23, or the fourth communication link 24.

For another example, when the first communication link 21 cannot support a communication requirement, the first component 11 and the second component 12 may communicate with each other through the second communication link 22, the third communication link 23, or the fourth communication link 24. Alternatively, the first component 11 and the second component 12 may communicate with each other through at least two of the first communication link 21, the second communication link 22, the third communication link 23, and the fourth communication link 24, to better satisfy a transmission requirement between the first component 11 and the second component 12. Therefore, reliability of the electronic and electrical system 10 of a vehicle can be improved.

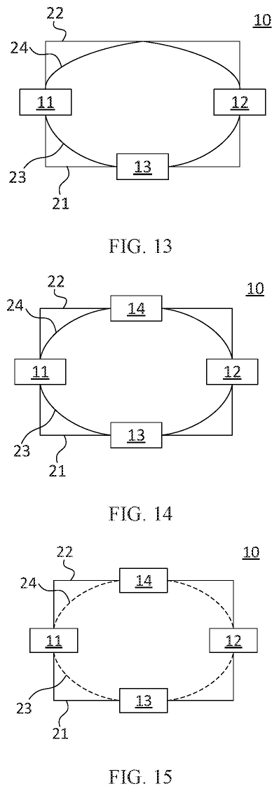

In some examples, as shown in FIG. 13, the electronic and electrical system 10 further includes a third component 13. The third component 13 is connected to the first communication link 21 and the third communication link 23 and is located between the first component 11 and the second component 12. In this way, communication between components can be implemented through a redundancy design of the first communication link 21, the second communication link 22, the third communication link 23, and the fourth communication link 24.

For example, when a communication fault occurs on a link of the first communication link 21 between the first component 11 and the third component 13, the third component 13 can communicate with the second component 12 through a link of the first communication link 21 between the second component 12 and the third component 13. Alternatively, the third component 13 can communicate with the first component 11 by using the second component 12 through at least one of the second communication link 22 or the fourth communication link 24. Alternatively, the third component 13 can communicate with the second component 12 through a link of the third communication link 23 between the second component 12 and the third component 13. Alternatively, the third component 13 can communicate with the first component 11 through a link of the third communication link 23 between the first component 11 and the third component 13.

In some other examples, as shown in FIG. 14, the electronic and electrical system 10 further includes a fourth component 14. The fourth component 14 is connected to the second communication link 22 and the fourth communication link 24 and is located between the first component 11 and the second component 12. Communication between components may be implemented through a redundancy design of the first communication link 21, the second communication link 22, the third communication link 23, and the fourth communication link 24.

For example, when a communication fault occurs on a link of the second communication link 22 between the first component 11 and the fourth component 14, the fourth component 14 can communicate with the second component 12 through a link of the second communication link 22 between the second component 12 and the fourth component 14. Alternatively, the fourth component 14 can communicate with the first component 11 by using the second component 12 through at least one of the first communication link 21 or the third communication link 23. Alternatively, the fourth component 14 can communicate with the second component 12 through a link of the fourth communication link 24 between the second component 12 and the fourth component 14. Alternatively, the fourth component 14 can communicate with the first component 11 through a link of the fourth communication link 24 between the first component 11 and the fourth component 14.

In some embodiments, a communication type of the third communication link 23 may be one of Ethernet communication, CAN communication, optical fiber communication, Wi-Fi communication, or Bluetooth communication. A communication type of the fourth communication link 24 may be one of Ethernet communication, CAN communication, optical fiber communication, Wi-Fi communication, or Bluetooth communication.

Herein, the communication types of the first communication link 21, the second communication link 22, the third communication link 23, and the fourth communication link 24 may be set to be different from each other, or at least two are the same. A gigabit dual-Ethernet ring network may be used between the first component and the second component, to implement transmission path redundancy through a unique dual-loop topology structure. Even if one connection is interrupted, a signal can still be stably transmitted, transmission can be continuously performed at a breakpoint, and a link is more optimized.

In some embodiments, as shown in FIG. 15, communication types of the first communication link 21 and the second communication link 22 are the same, a communication type of the third communication link 23 is different from a communication type of the first communication link 21, and a communication type of the fourth communication link 24 is the same as the communication type of the third communication link 23.

For example, the first communication link 21 is Ethernet communication, the second communication link 22 is the Ethernet communication, the third communication link 23 is CAN communication, and the fourth communication link 24 is the CAN communication. Alternatively, the first communication link 21 is Wi-Fi communication, the second communication link 22 is the Wi-Fi communication, the third communication link 23 is optical fiber communication, and the fourth communication link 24 is the optical fiber communication.

It may be understood that, in this solution, the first communication link 21 and the second communication link 22 may form a ring loop. In addition, the third communication link 23 and the fourth communication link 24 may also form a ring loop, to form a dual-ring network architecture, thereby constructing a path redundancy architecture and a bus redundancy architecture. In addition, the first communication link 21 and the second communication link 22 are redundant paths of a same communication type. When the first communication link 21 is faulty or the first communication link 21 cannot support a transmission requirement, communication between the first component 11 and the second component 12 may be implemented through the second communication link 22. In addition, when a ring network communication link formed by the first communication link 21 and the second communication link 22 is faulty or cannot support a transmission requirement, communication between the first component 11 and the second component 12 may be implemented through the third communication link 23 and the fourth communication link 24.

In some embodiments, ring links of different communication types may be mounted in parallel to form a double-layer ring network. Even if one bus is abnormal and cannot be used for communication, communication can be performed through another bus in parallel, thereby improving reliability of bus communication. For example, one ring network (for example, a ring network architecture including the first communication link 21 and the second communication link 22) may be a gigabit Ethernet bus, and the other ring network (for example, a ring network architecture including the third communication link 23 and the fourth communication link 24) may be a CAN with flexible data rate (CAN with Flexible Data rate, CANFD) bus.

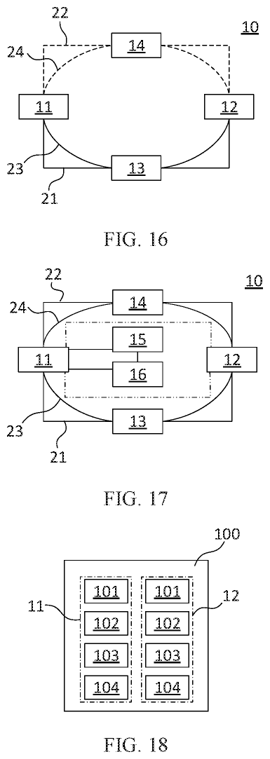

In some other embodiments, as shown in FIG. 16, communication types of the first communication link 21 and the second communication link 22 are different, a communication type of the third communication link 23 is the same as a communication type of the first communication link 21, and a communication type of the fourth communication link 24 is the same as the communication type of the second communication link 22.

For example, the first communication link 21 is Ethernet communication, the second communication link 22 is CAN communication, the third communication link 23 is the Ethernet communication, and the fourth communication link 24 is the CAN communication. Alternatively, the first communication link 21 is Wi-Fi communication, the second communication link 22 is optical fiber communication, the third communication link 23 is the Wi-Fi communication, and the fourth communication link 24 is the optical fiber communication.

It may be understood that, in this solution, the first communication link 21 and the third communication link 23 may form a ring loop. In addition, the second communication link 22 and the fourth communication link 24 may also form a ring loop, to form a dual-ring network architecture, thereby constructing a path redundancy architecture and a bus redundancy architecture.

In some embodiments, the electronic and electrical system 10 satisfy at least one of the following: The first component 11 may include at least one of a controller, a sensor, or an executor, or the second component 12 includes at least one of a controller, a sensor, or an executor. With reference to at least one of the foregoing path redundancy or bus redundancy architecture, stable communication between the first component 11 and the second component 12 can be maintained, and when one communication link between the first component 11 and the second component 12 is faulty or cannot support a transmission requirement, communication can still be performed through another communication link, so that stability of the electronic and electrical system 10 can be maintained.

In some examples, the first component 11 and the second component 12 may be different components. For example, the first component 11 is a controller, and the second component 12 is a sensor, or the first component 11 is a controller, the second component 12 is an executor, and the like. In this way, stable communication between different components can be implemented.

Certainly, in some other examples, the first component 11 and the second component 12 may alternatively be set to be same components. For example, the first component 11 is a controller, and the second component 12 is a controller, or the first component 11 is a sensor, the second component 12 is a sensor, and the like.

Further, the first component 11 and the second component 12 may be set to be mutually independent and serve as backups for each other to form a component redundancy architecture. With reference to at least one of the foregoing path redundancy or bus redundancy architecture, a dual redundancy or triple redundancy architecture is formed.

In some embodiments, at least one of the first component 11 or the second component 12 is a domain controller. With reference to at least one of the foregoing path redundancy or bus redundancy architecture, stable communication between the first component 11 and the second component 12 can be maintained, and when one communication link between the first component 11 and the second component 12 is faulty or cannot support a transmission requirement, communication can still be performed through another communication link, so that stability of the electronic and electrical system 10 can be maintained.

The first component 11 and the second component 12 may be configured to implement a same function. For example, the first component 11 may be configured to implement a first function, and the second component 12 may also be configured to implement the first function. The first component 11 and the second component 12 are component redundancy. When the first component 11 is faulty or cannot support a service requirement, the first function may be implemented through the second component 12.

The first component 11 and the second component 12 may be set to be mutually independent and serve as backups for each other to form a component redundancy architecture. With reference to at least one of the foregoing path redundancy or bus redundancy architecture, a dual redundancy or triple redundancy architecture is formed.

The first component 11 and the second component 12 may use an inter-domain redundancy design. The first component 11 and the second component 12 belong to different functional domains.

For example, the first component 11 and the second component 12 may be different domain controllers. At least one of the first component 11 or the second component 12 may include a power control function, a steering and braking function, a body control function, and a chassis control function. When a problem occurs on any of the two domain controllers, the power control function, the steering and braking function, the body control function, and the chassis control function can still run normally.

For another example, the first component 11 is a cross-domain computing controller, and the second component 12 is a right area controller. A brake network link may be connected between the first component 11 and the second component 12, and the brake network link may be set to be connected to a brake signal, a brake pedal signal, or the like. In addition, a power network link may be connected between the first component 11 and the second component 12, and the power network link may be set to be connected to a throttle signal, a power assembly signal, or the like.

In some embodiments, the first component 11 is configured to implement the first function, and the second component 12 is configured to implement the first function when the first component 11 is in a first state. When a single component is in the first state, the other component can take control to improve reliable operation of related functions such as parking brake and collision unlock, thereby greatly improving reliability and stability. The first component 11 and the second component 12 may be set to be mutually independent and serve as backups for each other to form a component redundancy architecture. With reference to at least one of the foregoing path redundancy or bus redundancy architecture, a dual redundancy or triple redundancy architecture is formed.

The first state includes a fault state or a state in which the first component 11 cannot independently satisfy a service requirement, so that when a single component is faulty or cannot satisfy a requirement, the other component takes over or a plurality of components run together, to further improve stability of the electronic and electrical system 10.

The first function may include at least one of a power control function, a steering function, a braking function, a body control function, or a chassis control function, to maintain a control function, a steering function, a braking function, a body control function, a chassis control function, and the like of the electronic and electrical system 10.

In some embodiments, the first component 11 may be a first domain controller of a vehicle, and the second component 12 may be a cross-domain computing controller of the vehicle, to maintain stable running of the vehicle. The first domain controller may be an intelligent driving domain controller, a cockpit domain controller, a right area controller, a front area controller, or a rear area controller, and may implement stable communication between the cross-domain computing controller and the intelligent driving domain controller, between the cross-domain computing controller and the cockpit domain controller, between the cross-domain computing controller and the right area controller, between the cross-domain computing controller and the front area controller, or between the cross-domain computing controller and the rear area controller through at least one of the foregoing path redundancy link or bus redundancy harness.

In some embodiments, the third component 13 may include at least one of a controller, a sensor, or an executor. In addition, the third component 13 may alternatively be a front area controller of the vehicle.

In some embodiments, the fourth component 14 may include at least one of a controller, a sensor, or an executor. In addition, the fourth component 14 may be a rear area controller of the vehicle.

In some embodiments, as shown in FIG. 17, the first component 11 may be a cross-domain computing controller, the second component 12 may be a right area controller, the third component 13 may be a rear area controller, and the fourth component 14 may be a front area controller. The first communication link 21 is connected to the cross-domain computing controller, the rear area controller, and the right area controller. The second communication link 22 is connected to the cross-domain computing controller, the front area controller, and the right area controller. The third communication link 23 is connected to the cross-domain computing controller, the rear area controller, and the right area controller. The fourth communication link 24 is connected to the cross-domain computing controller, the front area controller, and the right area controller.

The first communication link 21 may have a same communication type as that of the second communication link 22, the third communication link 23 may have a same communication type as that of the fourth communication link 24, and the first communication link 21 may have a different communication type from that of the third communication link 23.

In addition, the electronic and electrical system 10 may further include a fifth component 15 and a sixth component 16. The first component 11, the fifth component 15, and the sixth component 16 may be connected to form a ring network redundancy architecture through a communication link. For example, the fifth component 15 may be an intelligent driving domain controller, and the sixth component 16 may be a cockpit domain controller. The cross-domain computing controller, the intelligent driving domain controller, and the cockpit domain controller may be connected to form a ring network architecture through a communication link.

FIG. 17 is a diagram of a path redundancy and bus redundancy structure of a triple redundancy architecture based on a domain controller according to the present disclosure. In some embodiments of the present disclosure, a dual-ring network communication link is used, and transmission path redundancy is implemented through a unique dual-ring topology structure design. Even if one connection is interrupted, a communication connection between domain controllers can still be implemented through another path, so that a signal is stably transmitted, transmission can be continuously performed at a breakpoint, and a link is more optimized.

The cross-domain computing controller and the front area controller may communicate with each other through an Ethernet path. When the Ethernet path is abnormal, and therefore direct communication cannot be performed through the Ethernet, communication between the cross-domain computing controller and the front area controller can still be implemented by using an Ethernet connection between the cross-domain computing controller and the rear area controller and then through post-stage Ethernet bridging.

In addition, a Gigabit Ethernet bus may be used between the cross-domain computing controller and the front area controller, and is installed in parallel with a CAN bus, a CANFD bus, or a LIN bus to form a double-layer ring network, thereby implementing bus redundancy. The cross-domain computing controller, the right area controller, the front area controller, the rear area controller, the intelligent driving domain controller, and the cockpit domain controller implement multi-bus interconnection through the Ethernet, the CAN bus, the CANFD bus, and the LIN bus. After a connection of one bus of the Ethernet, the CAN bus, the CANFD bus, or the LIN bus between any two domain controllers is disconnected, a connection can still be implemented through the parallel Ethernet, CAN bus, CANFD bus, or LIN bus that is not disconnected.

In addition, as shown in FIG. 18, the first component 11 may include at least one of a power controller 101, a steering and braking controller 102, a body controller 103, or a chassis controller 104. The second component 12 may be the same as the first component 11, and the first component 11 and the second component 12 are independent of each other. In other words, the first component 11 and the second component 12 may communicate with another component equally, and the first component 11 and the second component 12 serve as backups for each other. When the first component 11 is faulty, the second component 12 can be used to replace the first component 11. When the second component 12 is faulty, the first component 11 can be used to replace the second component 12.

Some embodiments of the present disclosure provide a multi-redundancy architecture based on a domain controller. A redundancy architecture with at least two communication links exists between the first component 11 and the second component 12, and a key subsystem of a vehicle may be deployed on two mutually independent domain controllers at the same time, which serve as backups for each other. In the triple redundancy architecture based on the domain controller, an in-vehicle Gigabit Ethernet bus is installed in parallel with the CANFD bus to form a double-layer ring network.

In some embodiments of the present disclosure, FIG. 18 is a diagram of an inter-domain redundancy structure of a triple redundancy architecture based on a domain controller according to the present disclosure. As shown in FIG. 18, an asymmetric multi-processing (asymmetric multi-processing, AMP) architecture is used for deployment across cores, a system runs on both a first component 11 and a second component 12, and reliability of functions are improved in a dual-core locking step operation manner. Through bionic reference to an octopus heart, a key subsystem of a vehicle is deployed on two mutually independent domain controllers at the same time and serves as backups for each other.

In FIG. 18, a cross-domain computing controller (for example, the first component 11) and a right area controller (for example, the second component 12) are designed through an inter-domain redundancy design. Both the cross-domain computing controller and the right area controller include a power control function, a steering and braking function, a body control function, and a chassis control function. When any of the two domain controllers is faulty, the power control function, the steering and braking function, the body control function, and the chassis control function can still run normally. When a single controller fails, the other controller can take control to improve reliable operation of related functions such as parking brake and collision unlock, thereby greatly improving reliability and stability.

A communication type of each communication link in some embodiments of the present disclosure is not limited to the examples in the foregoing embodiments. Types and functions of components in some embodiments of the present disclosure are not limited to the examples in the foregoing embodiments.

Some embodiments of the present disclosure further provide a vehicle 100 (as shown in FIG. 18), including the foregoing electronic and electrical system 10. The vehicle 100 in some embodiments of the present disclosure may deploy a key subsystem on two mutually independent domain controllers at the same time, which serve as backups for each other, and three-layer redundancy is formed with reference to the foregoing dual-ring network architecture. When a single controller fails, the other can take control, and when one communication link is faulty, communication can be performed through a redundant communication link so that related functions such as parking brake and collision unlock may still run reliably, thereby greatly improving reliability and stability of the system.

It should be further understood that “first”, “second”, “third”, “fourth”, and various numeric numbers involved in this specification are distinguished only for easy description, but are not intended to limit the scope of the present disclosure.

It should be understood that in this specification, the term “and/or” is merely an association relationship that describes associated objects, and represents that three relationships may exist. For example, A and/or B may indicate that only A exists, both A and B exist, and only B exists. In addition, the character “/” in this specification usually represents an “or” relationship between the associated objects.

It should be understood that in various embodiments of the present disclosure, an order of serial numbers of the foregoing processes does not mean an order of execution. The order of execution of the processes should be determined according to functions and internal logic of the processes, and should not constitute any limitation on an implementation process of the embodiments of the present disclosure.

Those of ordinary skill in the art can recognize that the units and algorithm steps can be implemented in electronic hardware or a combination of computer software and the electronic hardware in combination with the units and algorithm steps of the examples described in the embodiments disclosed herein. Whether these functions are implemented in hardware or software depends on the specific application and design constraints of the technical solution. A person skilled in the art can implement the described functions through different methods for each specific application, but such implementation should not be considered to be beyond the scope of the present disclosure.

It may be clearly understood by a person skilled in the art that, for convenience and brevity of description, for a specific working process of the foregoing described system, apparatus, and unit, reference may be made to a corresponding process in the foregoing method embodiments, and details are not described herein again.

In several embodiments provided in the present disclosure, it should be understood that the disclosed system, apparatus, and method may be implemented in another manner. For example, the described apparatus embodiment is merely an example. For example, unit division is merely division of logical functions. In actual implementation, there may be another division manner. For example, a plurality of units or components may be combined or integrated into another system, or some features may be ignored or not performed. In addition, the mutual coupling or direct coupling or a communication connection shown or discussed may be indirect coupling or a communication connection implemented through some interfaces, apparatuses, or units, may be electrical or mechanical or may be of another form.

The units described as separate components may or may not be physically separate, and the components displayed as units may or may not be physical units, that is, may be located in one place, or may be distributed on across a plurality of network units. Some or all of the units may be selected based on actual needs to achieve the objectives of embodiments.

In addition, the functional units in embodiments of the present disclosure may be integrated into one processing unit, or each unit may exist separately physically, or two or more units may be integrated into one unit.

A function may be stored in a computer-readable storage medium if the function is implemented in a form of a software functional unit and sold or used as an independent product. Based on such an understanding, the technical solution of the present disclosure essentially, or the part contributing to a related technology, or a part of the technical solution may be implemented in a form of a software product. The computer software product is stored in a storage medium and includes several instructions for instructing a computer device (which may be a personal computer, a server, or a network device) to perform all or some of the steps of the methods of the embodiments of the present disclosure. The foregoing storage medium includes any medium that can store program code, such as a USB flash drive, a removable hard disk drive, a read-only memory (Read-Only Memory, ROM), a random access memory (Random Access Memory, RAM), a magnetic disk, or an optical disc.

The steps of the methods of the embodiments of the present disclosure can be sequentially adjusted, combined, and deleted according to actual requirements.

The modules of the apparatuses of the embodiments of the present disclosure may be combined, divided, and deleted according to actual requirements.

The foregoing embodiments are merely used to describe the technical solutions of the present disclosure, but are not limited thereto. Although the present disclosure is described in detail with reference to the foregoing embodiments, it should be understood by a person of ordinary skill in the art that the technical solutions described in the foregoing embodiments may still be modified, or equivalent replacements may be performed on some of the technical features. However, these modifications or replacements do not deviate the essence of the corresponding technical solutions from the scope of the technical solutions of the embodiments of the present disclosure.

1. An electronic and electrical system of a vehicle, comprising:
a first component;
a second component;
a first communication link communicatively connecting the first component and the second component; and
a second communication link communicatively connecting the first component and the second component,
wherein the first component and the second component are configured to communicate with each other through at least one of the first communication link or the second communication link.

2. The electronic and electrical system of claim 1, wherein communication types of the first communication link and the second communication link are the same, or communication types of the first communication link and the second communication link are different.

3. The electronic and electrical system of claim 2, wherein the electronic and electrical system satisfies at least one of the following:
the communication type of the first communication link is one of Ethernet communication, controller area network (CAN) communication, optical fiber communication, Wi-Fi communication, or Bluetooth communication; or
the communication type of the second communication link is one of Ethernet communication, CAN communication, optical fiber communication, Wi-Fi communication, or Bluetooth communication.

4. The electronic and electrical system of claim 2, wherein the communication types of the first communication link and the second communication link are the same, the electronic and electrical system further comprises a third communication link communicatively connecting the first component and the second component, and a communication type of the third communication link is different from the communication type of the first communication link.

5. The electronic and electrical system of claim 4, further comprising a fourth communication link communicatively connecting the first component and the second component, wherein a communication type of the fourth communication link is the same as the communication type of the third communication link.

6. The electronic and electrical system of claim 4, wherein a communication type of the third communication link is one of Ethernet communication, CAN communication, optical fiber communication, Wi-Fi communication, or Bluetooth communication.

7. The electronic and electrical system of claim 1, wherein the electronic and electrical system satisfies at least one of the following:
the first component and the second component are configured to communicate with each other through the second communication link when the first communication link is in a fault state; or
the first component and the second component are configured to communicate with each other through the first communication link and the second communication link when the first communication link cannot independently satisfy a service requirement.

8. The electronic and electrical system of claim 1, wherein the electronic and electrical system satisfies at least one of the following:
the first component comprises at least one of a controller, a sensor, or an executor; or
the second component comprises at least one of a controller, a sensor, or an executor.

9. The electronic and electrical system of claim 1, wherein at least one of the first component or the second component is a domain controller.

10. The electronic and electrical system of claim 1, wherein the first component is configured to implement a first function, and the second component is configured to implement the first function when the first component is in a first state.

11. The electronic and electrical system of claim 10, wherein the first state comprises one of a fault state and a state in which the first component cannot independently satisfy a service requirement.

12. The electronic and electrical system of claim 10, wherein the first function comprises at least one of a power control function, a steering function, a braking function, a body control function, or a chassis control function.

13. The electronic and electrical system of claim 1, wherein the first component is a first domain controller of the vehicle, and the second component is a cross-domain computing controller of the vehicle.

14. The electronic and electrical system of claim 1, further comprising at least one of:
a third component connected to the first communication link and located between the first component and the second component; or
a fourth component connected to the second communication link and located between the first component and the second component.

15. The electronic and electrical system of claim 14, wherein the electronic and electrical system satisfies at least one of the following:
the third component comprises at least one of a controller, a sensor, or an executor; or
the fourth component comprises at least one of a controller, a sensor, or an executor.

16. The electronic and electrical system of claim 14, wherein the third component is a front area controller of the vehicle, and the fourth component is a rear area controller of the vehicle.

17. A vehicle, comprising:
an electronic and electrical system including:
a first component;
a second component;
a first communication link communicatively connecting the first component and the second component; and
a second communication link communicatively connecting the first component and the second component,
wherein the first component and the second component are configured to communicate with each other through at least one of the first communication link or the second communication link.

18. The vehicle of claim 17, wherein communication types of the first communication link and the second communication link are the same, or communication types of the first communication link and the second communication link are different.

19. The vehicle of claim 18, wherein the electronic and electrical system satisfies at least one of the following:
the communication type of the first communication link is one of Ethernet communication, controller area network (CAN) communication, optical fiber communication, Wi-Fi communication, or Bluetooth communication; or
the communication type of the second communication link is one of Ethernet communication, CAN communication, optical fiber communication, Wi-Fi communication, or Bluetooth communication.

20. The vehicle of claim 18, wherein the communication types of the first communication link and the second communication link are the same, the electronic and electrical system further comprises a third communication link communicatively connecting the first component and the second component, and a communication type of the third communication link is different from the communication type of the first communication link.
